(19) United States
(12) Patent Application Publication
(10) Pub. No.: US 2015/0058926 A1
(43) Pub. Date: Feb. 26, 2015

(54) Shared Page Access Control Among Cloud Objects In A Distributed Cloud Environment

(71) Applicant: International Business Machines Corporation, Armonk, NY (US)

(72) Inventors: Charles J. Archer, Rochester, MN (US); Bin Cao, Rochester, MN (US); Phillip V. Mann, Rochester, MN (US)

(73) Assignee: International Business Machines Corporation, Armonk, NY (US)

(21) Appl. No.: 13/975,025

(22) Filed: Aug. 23, 2013

(51) Int. Cl. H04L 29/06

(52) U.S. Cl. CPC H04L 63/10
USPC 726/3

(57) ABSTRACT

A management system in a distributed cloud environment that includes a plurality of cloud object, may administer shared page access control among cloud objects. Such shared access control includes: receiving, by the management system from a requesting cloud object, a request to access a shared page; discovering, by the management system, one or more page attributes of the shared page, where the one or more page attributes of the shared page include attributes specified by one or more cloud objects of the distributed cloud environment; identifying, by the management system in dependence upon the page attributes, one more access control measures to perform; performing, by the management system in dependence upon the page attributes, the access control measures; and determining, by the management system, whether to grant the requesting cloud object access to the shared page.

### BACKGROUND OF THE INVENTION

1. Field of the Invention

The field of the invention is data processing, or, more specifically, methods, apparatus, and products shared page access control among cloud objects.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computer systems today are being utilized to form ‘cloud environments.’ A cloud environment, as the term is used in this specification refers to a virtualized computing platform in which a user may be provided access to computing resources without knowledge, ownership, or physical access to the computer resources. In such a cloud environment, many virtual machines are often instantiated on a single hardware server or on a cluster of hardware servers. In some environment, multiple virtual machines, or groups of virtual machines, operated by different users (such as different cloud customers) may be instantiated on the same set of hardware and have access to the same set of computing resources, such as memory, I/O devices, and the like. To that end, security between the different sets of virtual machines may become an issue.

As more companies move into a private, public, or hybrid cloud environment, security may become a greater issue. More specifically, companies often like to understand how their data is distributed, how secure the data is, and whether others have attempted to access that data. There are currently some security implementations utilized in cloud environment that attempt to address some of these security concerns and risks, such as:
1) request and approval policies. IBM's SmartCloud Entry™, for example, currently has a cloud administrator that handles all of the requests by other cloud users and manually approves or denies the incoming request. This can be time consuming and only deals with the virtual machine provisioning level.
2) security key and certificate authentication. Various cloud solutions have implemented a security key/certificate pairing to keep non-authenticated users from accessing certain cloud resources. This usually applies to access to certain virtual machines and if the key/certificate is compromised it is almost impossible to tell whom should be granted access and whom to prevent.

In a distributed cloud computing environment, with multiple cloud objects (such as virtual machines, virtual servers, threads, applications, and the like) that access common memory pages, a management system may instantiate one page from a pool of pages to operate as a single page for all VMs having an identical page. This ‘shared page’ technique reduces the number of memory pages that must be utilized in many cases, thereby reducing memory usage. Security in such a system amongst virtual machines accessing the shared pages, however, is not currently enforced in a fine-grained and efficient manner.

### SUMMARY

Methods, apparatus, and products for shared page access control among cloud objects in a distributed cloud environment are disclosed in this specification. The distributed cloud environment includes a management system coupled for data communications to a plurality of cloud objects. Access control to shared pages may be carried out by: receiving, by the management system from a requesting cloud object, a request to access a shared page; discovering, by the management system, one or more page attributes of the shared page, where the one or more page attributes of the shared page includes attributes specified by one or more cloud objects of the distributed cloud environment; identifying, by the management system in dependence upon the page attributes, one more access control measures to perform; performing, by the management system in dependence upon the page attributes, the access control measures; and determining, by the management system, whether to grant the requesting cloud object access to the shared page.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of an example system for shared page access control among cloud objects according to embodiments of the present invention.

FIG. 2 sets forth a flow chart illustrating an exemplary method for shared page access control among cloud objects according to embodiments of the present invention.

FIG. 3 sets forth a flow chart illustrating another exemplary method for shared page access control among cloud objects according to embodiments of the present invention.

### DETAILED DESCRIPTION OF EXEMPLARY EMBODIMENTS

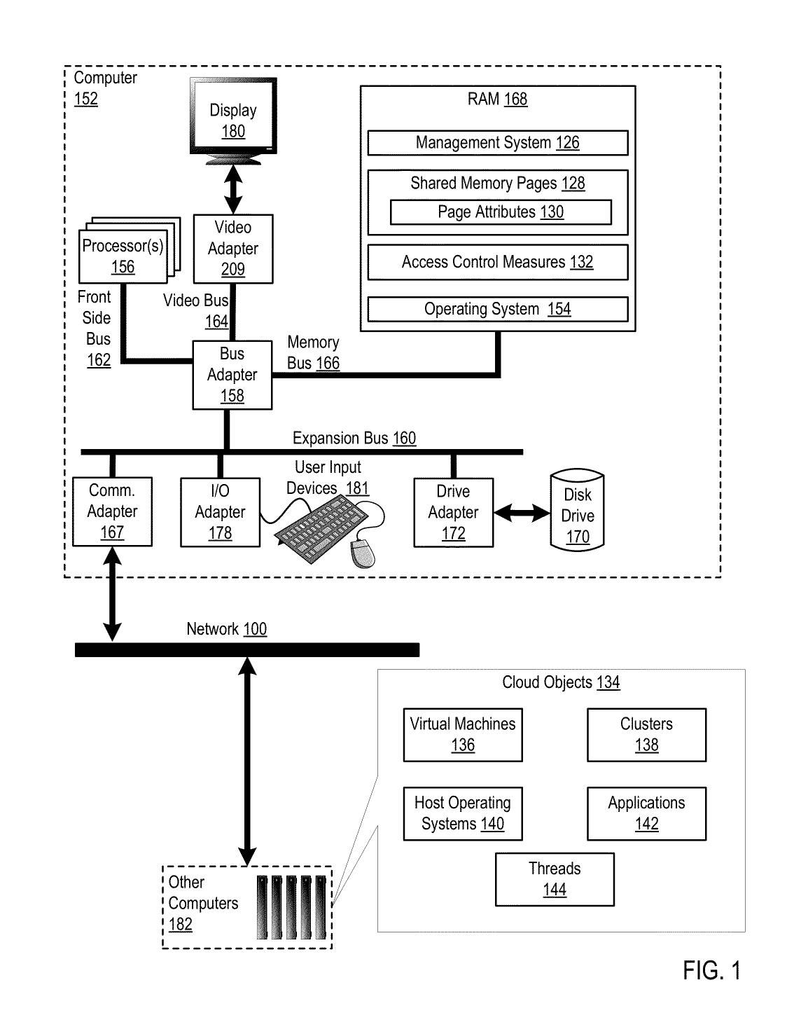

Exemplary methods, apparatus, and products for shared page access control among cloud objects in accordance with the present invention are described with reference to the accompanying drawings, beginning with FIG. 1. FIG. 1 sets forth a network diagram of an example ticket queuing system for shared page access control among cloud objects according to embodiments of the present invention.

The system of FIG. 1 includes several examples of automated computing machinery. One example of automated computing machinery includes the computer (152) which is configured for shared page access control among cloud objects according to embodiments of the present invention. The computer (152) of FIG. 1 includes at least one computer processor (156) or ‘CPU’ as well as random access memory (168) (RAM′) which is connected through a high speed memory bus (166) and bus adapter (158) to processor (156) and to other components of the computer (152).

Stored in RAM (168) is a management system, a module of computer program instructions that, when executed causes the computer (152) of FIG. 1 to operate control shared page access among cloud objects. The management system may also be configured to administer provisioning and recycling of virtual machines, cloud resources, memory, and the like; track customer or user usage of cloud resources; provide a systems management interface for configuration of virtual machine environments; and so on.

The term ‘shared page’ refers to a memory page that may be shared by several cloud objects, with or without the objects' knowledge that the page is shared. The term ‘cloud objects’ as used in this specification may refer to any object in the cloud computing environment which is capable of accessing shared memory pages. Examples of such cloud objects include virtual machines (136), clusters (138) of hardware devices or virtualized hardware, host operating systems (140), applications (142), threads or processes (144), and so on as will occur to readers of skill in the art. In the example of FIG. 1, several cloud objects (134) may be executed, instantiated, hosted, virtualized, or implemented by other computers (182) coupled via a data communications network (100) to the computer (152). Also, users (not shown here) may be coupled via one or more data communications network (100) to utilize the cloud objects (134).

In the example of FIG. 1, a plurality of the cloud objects (134) share several memory pages (128). Each page of memory has page attributes (130). Page attributes of the prior art typically describe various characteristics of the page including, for example, whether the page is read-only, has read or write access, has no access, age or usage attributes, among others. While high-level access control may be implemented via page attributes, such access controls are limited, not dynamically specified, and provide no other action to be carried out. That is, the access control set forth in the page attributes merely specifies whether the access request can be granted. The access controls provide no further fine-grained measures in a cloud environment, especially when such a page is shared among a plurality of cloud objects. To that end, the page attributes (130) in the example of FIG. 1 are extended to specify one or more access control measures to be performed upon the particular access requests.

An access control measure is a process, initiated or carried out by a system management module, in response to a specified access request by a cloud object that is not sharing a shared memory page. Consider, for example, that two virtual machines (VM_1 and VM_2) share a memory page. One of the two virtual machines may include page attributes in the shared memory page that indicate that all VMs sharing the memory page be notified of any read access by a VM not sharing the memory page, successful or otherwise, and a copy of the shared memory page be made at the time of the read request for later inspection.

In the example of FIG. 1, the management system (126) may control shared page access control among the cloud objects (134) in accordance with embodiments of the present invention by receiving, from a requesting cloud object, a request to access a shared page (128); discovering one or more page attributes (130) of the shared page (128). The one or more page attributes (128) of the shared page include attributes specified by one or more cloud objects (134) of the distributed cloud environment. Then the management system (126) may identify, by the management system in dependence upon the page attributes (130), one more access control measures (132) to perform and may perform the access control measures. Additionally, the management system (126), may determine whether to grant the requesting cloud object (134) access to the shared page. That is, in some embodiments, the requesting cloud object may be granted access to the shared page, even in the case where access control measures are performed. Further, it should be noted that the access request may be received from a cloud object that is currently sharing the same memory page or from a cloud object that is not. In some embodiments, some types of access requests may be prohibited even when the requesting cloud object shares the memory page and is authorized to perform other access requests with respect to the memory page.

Also stored RAM (168) of each computer (152) is an operating system (154). Operating systems useful for shared page access control among cloud objects according to embodiments of the present invention include UNIX™, Linux™, Microsoft XP™, AIX™, IBM's i5/OS™, and others as will occur to those of skill in the art. The operating systems (154), monitoring module (126), ticket queuing module (144) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for shared page access control among cloud objects according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (′I/O′) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for shared page access control among cloud objects according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional databases, servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

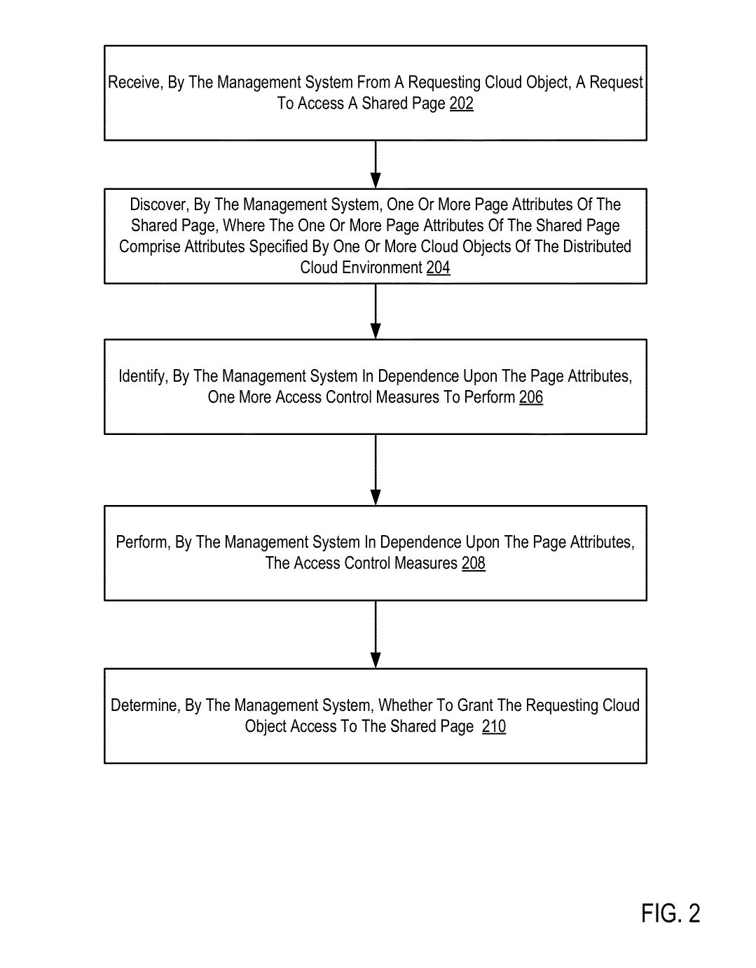

For further explanation, FIG. 2 sets forth a flow chart illustrating an exemplary method for shared page access control among cloud objects according to embodiments of the present invention. In the method of FIG. 2, the distributed cloud environment includes a management system (similar to that shown in the system of FIG. 1) coupled for data communications to a plurality of cloud objects (like those depicted in the example of FIG. 1).

The method of FIG. 2 includes receiving (202), by the management system from a requesting cloud object, a request to access a shared page. Receiving (202), by the management system from a requesting cloud object, a request to access a shared page may be carried out via data communications across one or more data communications networks. It is noted that in some cloud environments according to embodiments of the present invention, all access requests to shared memory pages (and possibly to non-shared memory pages) by a cloud object must initially be sent to the management system in some form. In some embodiments, the cloud object requesting access may do so directly to the management system, while in other environments a hypervisor supporting one or more virtual machines handles the initial access request and passes along the requests to the management system to be processed for access control measures.

The method of FIG. 2 also includes discovering (204), by the management system, one or more page attributes of the shared page. In the method of FIG. 2, the one or more page attributes of the shared page include attributes specified by one or more cloud objects of the distributed cloud environment. Cloud objects, sharing the page, for example, may specify the page attributes such that the management system can discover, identify and perform the desired access control measures. Discovering (204), by the management system, one or more page attributes of the shared page may be carried out by inspecting the page of attributes of the page (which may be stored in metadata or embedded within the page itself) and determining that the attributes include in predefined memory locations (or bit/byte positions) attributes indicating access control measures to be carried out.

The method of FIG. 2 also includes identifying (206), by the management system in dependence upon the page attributes, one more access control measures to perform. Identifying (206) one more access control measures to perform in dependence upon the page attributes may be carried out in a variety of ways. For example, the attributes may be implemented as an index into a table or other data structure, where the value of the index points to a record representing an access control measure.

Further, the record representing the access control measure may include many types of data in addition to the process to be performed. For example, the record may specify one or more identifiers of cloud objects (an IP address, a Media Access Card address, a VM instance identifier, or other identifier) for which the access control measure process is to be performed if the any one of those identifiers is the identifier of the access request.

The method of FIG. 2 also includes performing (208), by the management system in dependence upon the page attributes, the access control measures and determining (210), by the management system, whether to grant the requesting cloud object access to the shared page. Determining (210) whether to grant the requesting cloud object access to the shared page may be carried out in dependence upon the page attributes as well, but not those attributes related to the fine-grained access control measures.

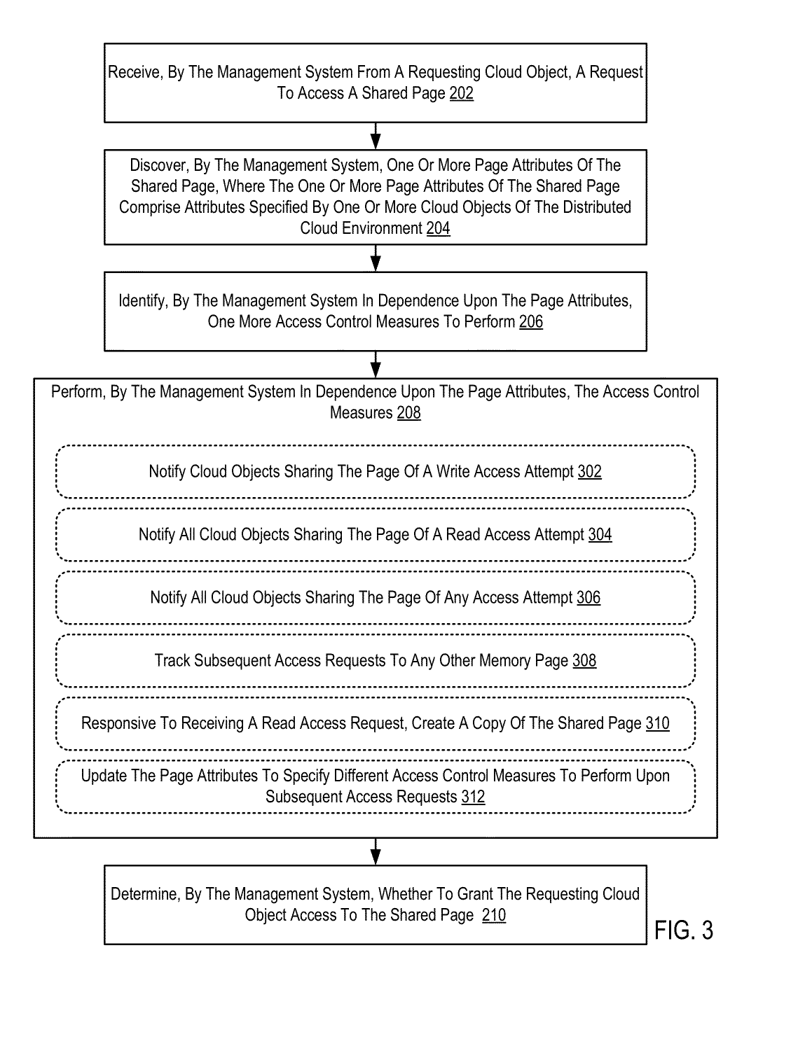

For further explanation, FIG. 3 sets forth a flow chart illustrating another exemplary method for shared page access control among cloud objects according to embodiments of the present invention. The method of FIG. 3 is similar to the method of FIG. 2 in that the method of FIG. 3 also includes receiving (202) a request to access a shared page; discovering (204) one or more page attributes of the shared page; identifying (206) one more access control measures to perform; performing (208) the access control measures; and determining (210) whether to grant the requesting cloud object access to the shared page.

The method of FIG. 3 differs from the method of FIG. 2, however, in that the method of FIG. 3 sets forth several example ways to carry out performing (208) the access control measures. Although the method of FIG. 3 sets forth several example methods for performing (208) access control measures, readers of skill in the art will recognize that any combination of these measures, as well as other measures not shown here, is well within the scope of the present invention. That is, page attributes may specify a plurality of access control measures to perform, in any combination, rather than merely one access control measure.

To that end, in the method of FIG. 3, performing (208) access control measures may include notifying (302) cloud objects sharing the page of a write access attempt in dependence upon page attributes specifying one or more cloud objects not having write access to the shared page. In typical cloud environments, any write access to a shared memory pages causes the page to be copied so that those sharing the page are not affected by the write. As such, a user of a cloud object may desire knowledge of any write access attempts by a particular non-authorized cloud object to a shared page even if that write access did not directly affect the page utilized by the cloud object. Further, upon a notification, a user of the cloud object may change the page attributes dynamically (as set forth below with regard to element (312)) to take other access control measures with regard to the activity of the requesting cloud object. Such is true for each of the following access control processes described below.

Performing (208) access control measures in the method of FIG. 3 may also include notifying (304) all cloud objects sharing the page of a read access attempt in dependence upon page attributes specifying one or more cloud objects not having read access to the shared page. In some cases, a read attempt of a shared memory page may be an attempt by a cloud object to gain information otherwise restricted form that object.

Performing (208) access control measures in the method of FIG. 3 may also include notifying (306) all cloud objects sharing the page of any access attempt. In this example, all cloud objects sharing the page may be notified of any access attempt. This is an example of a “broadcast-on-any” access attempt.

Performing (208) access control measures in the method of FIG. 3 may also include tracking (308), responsive to receiving the access request, subsequent access requests by the requesting cloud object, to any other memory page. Here, the management system may begin to create a history of the requesting cloud objects actions from the time of a particular access attempt to a shared memory page (authorized or otherwise). In this way, a user may later utilize that history to infer whether the access attempt was malicious or accidental.

Performing (208) access control measures in the method of FIG. 3 may also include creating (310), responsive to receiving a read access request, a copy of the shared page. As mentioned above, in response to a write access request, a separate instance of the page is made prior to applying the write to a shared memory page ensuring that each cloud object sharing the page has a copy of the page in the state that the object expects the page to be in. In a similar manner, a user may specify in page attributes, access control measures that specify creating a copy of the shared memory page upon a read access attempt. Such a copy may be useful as an exact history of the information read or attempted to be read by the requesting control object. Effectively, a user may be able to identify the actual information accessed in the case in which the requesting cloud object is a performing a malicious access attempt.

Performing (208) access control measures in the method of FIG. 3 may also include updating (312) the page attributes to specify different access control measures to perform upon subsequent access requests. That is, the page attributes may actually be updated dynamically, on-the-fly, as a result of performing an access control measure. In this way, a user may escalate security upon necessity without having to monitor the cloud object at all times.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of shared page access control among cloud objects in a distributed cloud environment, the distributed cloud environment including management system coupled for data communications to a plurality of cloud objects, the method comprising:
receiving, by the management system from a requesting cloud object, a request to access a shared page;
discovering, by the management system, one or more page attributes of the shared page, wherein the one or more page attributes of the shared page comprise attributes specified by one or more cloud objects of the distributed cloud environment;
identifying, by the management system in dependence upon the page attributes, one more access control measures to perform;
performing, by the management system in dependence upon the page attributes, the access control measures; and
determining, by the management system, whether to grant the requesting cloud object access to the shared page.

2. The method of claim 1 wherein performing, by the management system in dependence upon the page attributes, the access control measures further comprises:
notifying cloud objects sharing the page of a write access attempt in dependence upon page attributes specifying one or more cloud objects not having write access to the shared page, where the request to access the shared page comprises a write access request received from one of the cloud objects specified as not having write access.

3. The method of claim 1 wherein performing, by the management system in dependence upon the page attributes, the access control measures further comprises:
notifying all cloud objects sharing the page of a read access attempt in dependence upon page attributes specifying one or more cloud objects not having read access to the shared page, where the request to access the shared page comprises a read access request received from one of the cloud objects specified as not having read access.

4. The method of claim 1 wherein performing, by the management system in dependence upon the page attributes, the access control measures further comprises:
notifying all cloud objects sharing the page of any access attempt.

5. The method of claim 1 wherein performing, by the management system in dependence upon the page attributes, the access control measures further comprises:
responsive to receiving the access request, tracking subsequent access requests by the requesting cloud object, to any other memory page.

6. The method of claim 1 wherein performing, by the management system in dependence upon the page attributes, the access control measures further comprises:
responsive to receiving a read access request, creating a copy of the shared page.

7. The method of claim 1 wherein performing, by the management system in dependence upon the page attributes, the access control measures further comprises:
updating the page attributes to specify different access control measures to perform upon subsequent access requests.

8. The method of claim 1 wherein the page attributes specify a plurality of access control measures to perform.

9. An apparatus for shared page access control among cloud objects in a distributed cloud environment, the distributed cloud environment including management system coupled for data communications to a plurality of cloud objects, a computer memory operatively coupled to the computer processor, the computer memory having disposed within it computer program instructions that, when executed by the computer processor, cause the apparatus to carry out the steps of:
receiving, by the management system from a requesting cloud object, a request to access a shared page;
discovering, by the management system, one or more page attributes of the shared page, wherein the one or more page attributes of the shared page comprise attributes specified by one or more cloud objects of the distributed cloud environment;
identifying, by the management system in dependence upon the page attributes, one more access control measures to perform;
performing, by the management system in dependence upon the page attributes, the access control measures; and
determining, by the management system, whether to grant the requesting cloud object access to the shared page.

10. The apparatus of claim 9 wherein performing, by the management system in dependence upon the page attributes, the access control measures further comprises:
notifying cloud objects sharing the page of a write access attempt in dependence upon page attributes specifying one or more cloud objects not having write access to the shared page, where the request to access the shared page comprises a write access request received from one of the cloud objects specified as not having write access.

11. The apparatus of claim 9 wherein performing, by the management system in dependence upon the page attributes, the access control measures further comprises:
notifying all cloud objects sharing the page of a read access attempt in dependence upon page attributes specifying one or more cloud objects not having read access to the shared page, where the request to access the shared page comprises a read access request received from one of the cloud objects specified as not having read access.

12. The apparatus of claim 9 wherein performing, by the management system in dependence upon the page attributes, the access control measures further comprises:
notifying all cloud objects sharing the page of any access attempt.

13. The apparatus of claim 9 wherein performing, by the management system in dependence upon the page attributes, the access control measures further comprises:
responsive to receiving the access request, tracking subsequent access requests by the requesting cloud object, to any other memory page.

14. The apparatus of claim 9 wherein performing, by the management system in dependence upon the page attributes, the access control measures further comprises:
responsive to receiving a read access request, creating a copy of the shared page.

15. The apparatus of claim 9 wherein the page attributes specify a plurality of access control measures to perform.

16. A computer program product for shared page access control among cloud objects in a distributed cloud environment, the distributed cloud environment including management system coupled for data communications to a plurality of cloud objects, the computer program product disposed upon a computer readable medium, the computer program product comprising computer program instructions that, when executed, cause a computer to carry out the steps of:
receiving, by the management system from a requesting cloud object, a request to access a shared page;
discovering, by the management system, one or more page attributes of the shared page, wherein the one or more page attributes of the shared page comprise attributes specified by one or more cloud objects of the distributed cloud environment;
identifying, by the management system in dependence upon the page attributes, one more access control measures to perform;
performing, by the management system in dependence upon the page attributes, the access control measures; and
determining, by the management system, whether to grant the requesting cloud object access to the shared page.

17. The computer program product of claim 16 wherein performing, by the management system in dependence upon the page attributes, the access control measures further comprises:
notifying cloud objects sharing the page of a write access attempt in dependence upon page attributes specifying one or more cloud objects not having write access to the shared page, where the request to access the shared page comprises a write access request received from one of the cloud objects specified as not having write access.

18. The computer program product of claim 16 wherein performing, by the management system in dependence upon the page attributes, the access control measures further comprises:
notifying all cloud objects sharing the page of a read access attempt in dependence upon page attributes specifying one or more cloud objects not having read access to the shared page, where the request to access the shared page comprises a read access request received from one of the cloud objects specified as not having read access.

19. The computer program product of claim 16 wherein performing, by the management system in dependence upon the page attributes, the access control measures further comprises:
notifying all cloud objects sharing the page of any access attempt.

20. The computer program product of claim 16 wherein performing, by the management system in dependence upon the page attributes, the access control measures further comprises:
responsive to receiving the access request, tracking subsequent access requests by the requesting cloud object, to any other memory page.
